(19) United States
(12) Patent Application Publication
(10) Pub. No.: US 2003/0211011 A1
(43) Pub. Date: Nov. 13, 2003

(54) Ph sensor system and method for using same

(76) Inventors: Terry E. Phillips, Ellicott City, MD (US); Rengaswamy Srinivasan, Ellicott City, MD (US); C. Brent Bargeron, Columbia, MD (US); Hassan Saffarian, Silver Spring, MD (US); Elizabeth R. Schemm, Clarksville, MD (US)

Correspondence Address: Ernest R Graf Office of the Patent Counsel, The John Hopkins University, Applied Physics Laboratory, 11100 John Hopkins Road, Laurel, MD, 20723-6099, US

(21) Appl. No.: 10/311,169

(22) PCT Filed: Jun. 8, 2001
(86) PCT No.: PCT/US01/18694

(51) Int. Cl. G01N 21/27

(52) U.S. Cl. 422/82.05; 436/163

(57) ABSTRACT

A pH sensor system (10) and method capable of monitoring the pH level of a medium based on the characteristics of a chromatic pH sensitive material employed in the pH sensor system is provided. The pH sensor system includes at least a housing (12) having at least one transparent surface (14); a light sensitive circuitry (15), e.g., a LED (16) and photo-detector (18), enclosed within the housing; and, a chromatic pH sensitive material (20) overlaying at least a portion of the transparent surface having the characteristic of becoming saturated when an ambient pH level reaches a predetermined level such that the light sensitive circuitry detects a different intensity of incident light when the chromatic pH sensitive material is saturated than when the chromatic pH sensitive material is not saturated. As the pH level of the medium, e.g., concrete, storage tanks containing chemical reagents, etc., to be monitored steadily decreases, the pH sensitive material on the transparent surface of the housing will gradually become saturated with hydrogen ions and colorless. When the pH level reaches the predetermined level, the pH sensitive material will be unable to absorb any light being emitted from the LED such that the light is reflected back to the photo-detector.

### CROSS-REFERENCE TO RELATED APPLICATIONS

This application claims priority to U.S. Provisional Application No. 60/210,547, filed Jun. 9, 2000, entitled “Embeddable Solid State Sensor for pH Monitoring in Concrete and Other Mediums” of Phillips et al. The contents of the aforesaid U.S. Provisional Application No. 60/210,547 are hereby incorporated by reference.

### BACKGROUND OF THE INVENTION

1. Field of the Invention

The present disclosure relates generally to monitoring the pH level of a medium. More particularly, the present disclosure is directed to a pH sensor system and method for monitoring the pH level of a medium such as, for example, concrete, by embedding the sensor system within the medium.

2. Description of the Related Art

In the United States, billions of dollars have been spent in the construction of highways, freeways and their associated overpasses, bridges and buildings. An important problem facing the nation concerns determining how to maintain the integrity of this system of roads and other structures at an acceptable cost.

A problem which reduces the integrity of roadways, related structures and buildings is the corrosion of the contained reinforcing material by sources of chlorides, e.g., chloride-based deicers, seawater and other various sources of chlorides. The reinforcing material is typically a high resistance steel bar especially sensitive to deterioration through the effect of corrosion due to the action of oxygen. A “passivation” layer typically forms on the steel surface of the bar when it comes into contact with freshly prepared wet concrete to provide protection against corrosion of the reinforcement bars. In some cases, the reinforcement bars are enveloped in a continuous sheath of PVC or, polyethylene, and more recently, epoxy. Locations where the polymer coating is damaged, broken and has a “holiday,” the passivation layer forms on the steel, protecting it from corrosion.

The formation of the passivation layer on steel reinforcement bars is related to the pH of concrete, which is an alkaline medium with a pH of around 13. The passivation layer is, in most part, comprised of the oxides of iron which is formed by the reaction between iron and the hydroxide ions in concrete. In principle, this protection against corrosion should be sufficient because it provides a barrier against further oxidation of steel.

However, when the pH level of the concrete changes, and reaches a level of around 11 or lower, the oxide film (passivation layer) becomes unstable resulting in little to no protection to the steel. In the absence of proper protection, the steel surface is vulnerable to chloride (salt) attack, which causes pitting corrosion. This, in turn, causes the roadways and structures formed from the reinforced concrete to degrade and ultimately fail. The parameters that contribute to the change in the pH of concrete are environmental conditions such as, for example, acid rain and carbon dioxide. Note that the “buffer capacity” of freshly prepared concrete is high. Therefore, it will take several years of exposure of the concrete structure to these environmental conditions before the pH level of the concrete decreases from 13 to 12. However, once the pH level drops to 12, the concrete loses its buffer capacity, therefore very little acid rain or carbon dioxide is required to further lower the pH. Thus, accelaration of the decrease in pH will occur.

At a potential cost of billions of dollars, the nation is confronted with the task of repairing its highway system and other structures by removing the corroding reinforcing steel and replacing it with new reinforcing material. If the corroded steel is not replaced and corrosion is allowed to continue to critical stages, the road surfaces and structures may potentially fail catastrophically with associated human losses. Presently, there are several attempts to monitor the environment inside concrete for corrosivity using chloride sensors. The most popular chloride sensors for concrete are based on the silver/silver chloride (Ag/AgCl) electrode (AgCl+e⁻=Ag+Cl⁻). These sensors have received much attention for a fairly long period of time. However, obtaining an accurate estimate of Cl⁻ concentration in concrete employing these sensors remains difficult for several reasons. For example, Ag/AgCl electrodes need a stable, calibrated reference, and a good contact between the sensor and the medium. Furthermore, complexation reactions between free Cl⁻ ion and aluminate (one of the components of concrete), or adsorption of Cl⁻ ion to the other components of concrete may limit the use of electrochemical sensors.

Recently, it has been demonstrated that nuclear magnetic resonance (NMR) can be used to measure Cl⁻ in concrete. Other programs are underway to construct miniature NMR (NMR-on-a-Chip) just for this purpose. However, NMR does not have the same types of limitations as the electrochemical sensors. Thus, it is far from being a mature technology that could be used in concrete structures.

The lack of accurate in situ data on chloride ion concentration inside concrete complicates the prediction of pitting in steel. This limitation is further compounded by lack of pH data. It is arguable whether change in pH is more important to corrosion than chloride concentration. Regardless of the relative importance of these two parameters, it is clear that a maintenance-free, embeddable (i.e., chemically and physically stable for the duration of the life of the structure, and compatible in size with the size of the aggregates found in concrete), miniature pH sensor system will be valuable in monitoring the internal environment of concrete, as it changes from benign (pH>13) to corrosive (pH<12).

Since the sensor is small and comparable to the aggregates in concrete, it can be embedded in large numbers in a distributed fashion across the entire structure. The ubiquitous presence of a pH sensor will provide valuable data virtually at every location of the structure. This will help predict locations within the structure that are more vulnerable to corrosion than others. One can use this information to plan repair schedules before corrosion begins, thus saving valuable time and resources. Due to the increasing need for good management practices, a large number of embeddable sensors are being developed by various organizations.

An example of one of the more comparable suite of sensors is the embeddable microinstruments developed by the University of Virginia and the Virginia Transportation Research Council, which is described in their web-site www.vatechnologies.com. The current version of this unit is encased in plastic and needs external wire connections for power and measurement. The same web-site also describes a concept for a wireless version; it has a rechargeable battery which will need periodic recharging during the lifetime of the sensor and is expected to carry an RF link for communication. The Virginia sensor suite does not yet have telemetry, requires a battery or an external power source, and is much bigger in size than the aggregates found in concrete.

Another example is a sensor developed by the University of Virginia that is titled “In situ Sensor for Critical Corrosion Conditions in a Material” by Taylor et al, described at the web-site www.uvapf.org/technology/viewInvention.cfm?inventionID=26. It measures changes in the resistance in a steel wire that is buried in the concrete, but not connected to the rebar. The wire is the sensor; and the corrosive agent entering the concrete corrodes the wire, thinning the wire and changing its resistance. It is an indirect method to infer corrosion of the rebar. The University of Virginia sensor does not measure the corrosion in the rebar. Most importantly, their sensor requires external wire contact for measurements, which means wires will be hanging from the bridge deck. Wires and their associated connectors is a common source of reliability problems in field instrumentation. From an operational perspective, hanging wires are not desirable characters in structures such as bridges. Therefore, in its present form and purpose, the University of Virginia sensor may not be useful to monitor corrosion in bridge decks.

Other examples of sensors are the fiberoptics-based chloride sensors developed by the Vermont DOT, the University of Vermont (Laser Focus World, March 1998, p. 47) and Ontario, Canada (Ontario Ministry of Transportation and Communication, 1986) that measure changes in chloride concentration in concrete. Initial testing in concrete has shown that the chloride sensing elements need further improvement for long term stability. Furthermore, they depend upon external fiberoptic cables for communication.

There have been several attempts to embed corrosion sensors in concrete in Europe. A report by John Broomfield in the March 2001 issue of Materials Performance is one such example. It is an indirect technique, based on measuring corrosion in coupons (see, the web-site www.pbroomfield.fsnet.co.uk/condition.htm#resist for more information).

At this present time, the inventors are unaware of any published literature and/or patent document that describe a pH sensor that is embeddable in concrete or other such mediums.

Accordingly, a need exists for a pH sensor system for accurately monitoring the pH level of concrete or other such medium having a pH level similar to that of concrete. In this manner, when the pH of the medium reaches a predetermined level, protective measures can be promptly taken to ensure that the medium does not degrade prematurely.

### SUMMARY OF THE INVENTION

There is provided a pH sensor system and method capable of monitoring the pH level of a medium based on the characteristics of a chromatic pH sensitive material employed in the pH sensor system. The pH sensor system includes at least a housing having at least one transparent surface; a light sensitive circuitry, e.g., a circuitry having at least a LED and photo-detector, enclosed within the housing; and, a chromatic pH sensitive material overlaying at least a portion of the transparent surface having the characteristic of becoming saturated with hydrogen ions when an ambient pH level reaches a predetermined level, wherein the light sensitive circuitry detects a different intensity of incident light when the chromatic pH sensitive material is saturated than when the chromatic pH sensitive material is not saturated. The pH sensor system monitors the pH level of the surrounding medium by way of the pH sensitive material on the transparent surface. As the pH level of the medium steadily decreases, the pH sensitive material on the transparent surface of the housing will gradually be saturated with hydrogen ions such that the pH sensitive material becomes colorless. Upon the pH sensitive material becoming saturated with hydrogen ions and therefore reaching a colorless state, the material is unable to absorb any light emitted from the LED such that the light is reflected back to the photo-detector.

The monitoring process entails embedding the pH sensor system in the medium, e.g., concrete, storage tanks, etc., to be monitored. As the pH level of the medium decreases to a level where the medium may sufficiently degrade, e.g., a level of less than or equal to about 12, the pH sensitive material is saturated with hydrogen ions and becomes colorless. It is advantageous to monitor the pH level so that the medium does not prematurely degrade to the point that preventive measures may not be implemented.

### BRIEF DESCRIPTION OF THE DRAWINGS

FIG. 1 is a schematic representation of a pH sensor system in accordance with the present disclosure;

FIG. 2 is a circuit diagram of a pH sensor system according to the present invention;

FIG. 3 shows the configuration of the setup of sol-gel on a glass slide;

FIG. 4 shows the glass slide containing the sol-gel in conjunction with a LED/photodiode arrangement; and

FIG. 5 shows the glass slide containing the sol-gel with cement thereon.

### DESCRIPTION OF THE PREFERRED EMBODIMENT

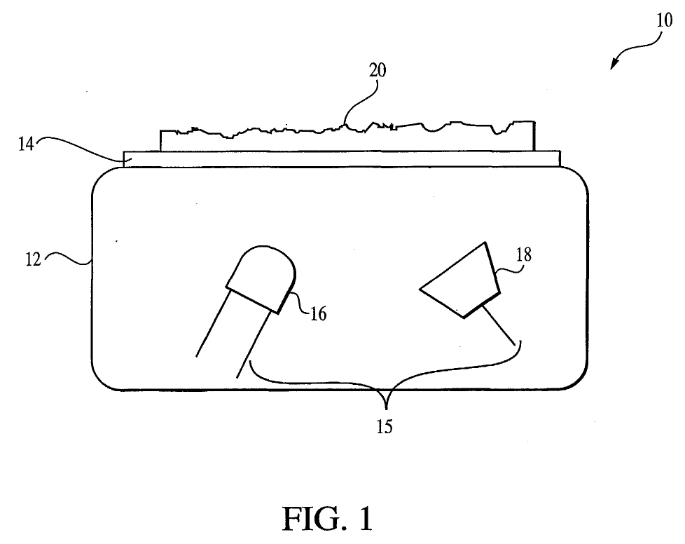

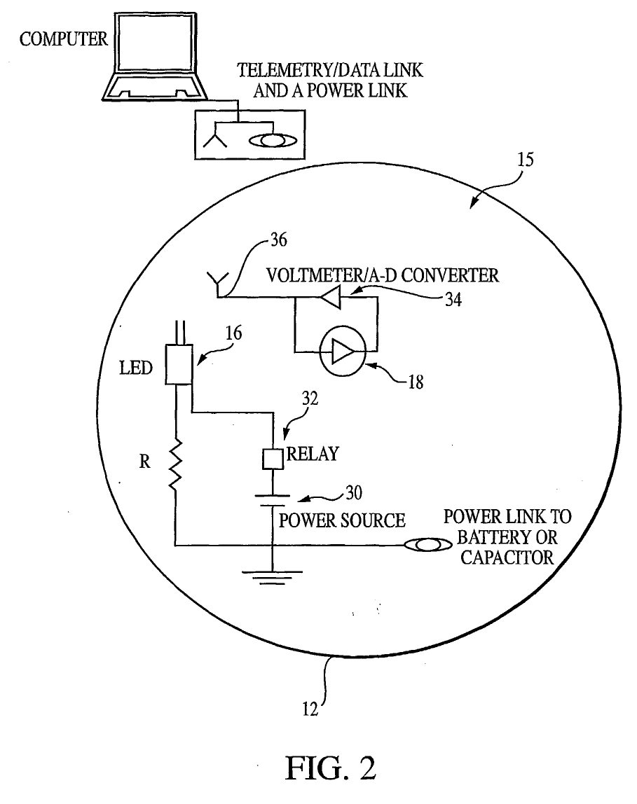

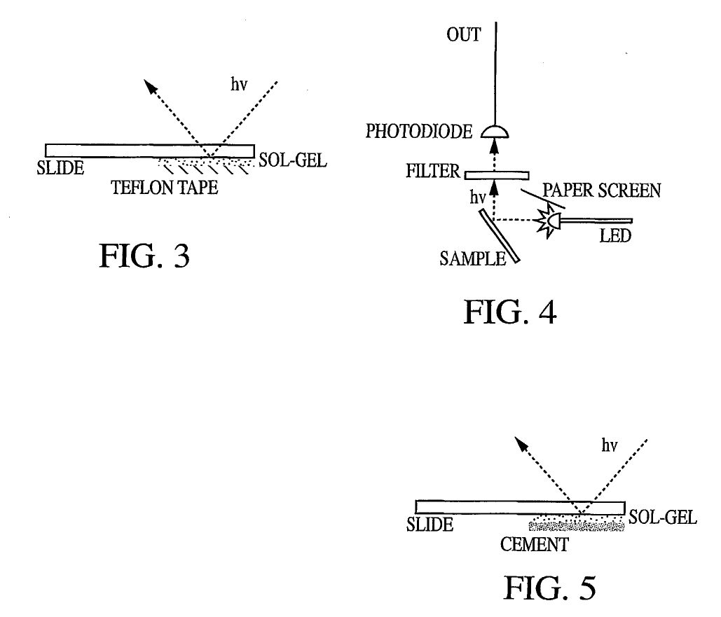

A detailed description will now be provided of the invention in conjunction with FIGS. 1 and 2 followed by a discussion of results from examples carried out in conjunction with FIGS. 3-5.

Referring now to FIG. 1, pH sensor system 10 of the present disclosure includes at least housing 12 having at least one transparent surface 14, light sensing circuitry 15 enclosed within housing 12 and having at least a light emitting diode (LED) 16 and photo-detector 18, e.g., a semiconductor pin photodiode or avalanche photodiode, and a chromatic pH sensitive material 20 overlaying at least a portion of the transparent surface 14. In general, housing 12 will be formed from conventional materials known in the art. Suitable materials for use herein include, but are not limited to, ceramic materials, e.g., alumina, macor, etc.; plastic materials; nylon; concrete; epoxy and the like. As one skilled in the art would readily appreciate, dimensions and configurations for housing 12 can vary accordingly and can be determined on a case by case basis. Housing 12 will have at least one surface 14 that is optically transparent. That surface is transparent to light having a wavelength of from about 300 to about 500 nm, which is the wavelength of light emitted by the LED 16. Useful materials for transparent surface 14 include, but are not limited to, glass, sapphire and the like.

A pH sensitive material 20 will be applied on at least a portion of the (the part that is exposed to the medium) transparent surface 14 of housing 12. Material 20 will advantageously be formed from an inert material and a pH indicator. If prepared according to the procedure prescribed later in this document, material 20 will absorb at least some part of light that is within the range of about 300 to about 500 nm. By employing pH sensitive material 20 formed from at least the pH indicator with the inert material and suitable catalyst on the transparent surface, the color of the pH sensitive material 20 will change from a color state to a colorless state as material 20 becomes saturated with hydrogen ions. In essence, the color of the pH sensitive material 20 changes as a function of pH immobilized within the material on the basis of a waveguide. Accordingly, any changes in pH of the medium being monitored will be reflected in a color change in the pH indicator in the inert material as the pH sensitive material becomes saturated with hydrogen ions. When the chromatic pH sensitive material 20 is substantially saturated with hydrogen ions, the pH sensitive material will be colorless. This, in turn, results in the light emitted from the LED to reflect off of pH sensitive material 20 which increases the voltage output of the photo-detector. The actual level of voltage depends upon the details of the electronics (e.g., amplifier and A/D converter) employed to measure the voltage. It also depends upon the wavelength of the light (of the LED source). For example, if the wavelength of the light is about 355±20 nm, then if the voltage of the photo-diode reaches a certain level, e.g., to about 500% of its original value, the pH of the medium reaches a predetermined level different from the original ambient pH of the medium thereby indicating that the medium has turned corrosive, as discussed hereinbelow. If the wavelength of the light is about 425±20 nm, then an increase of, for example, 120% increase in the output voltage of the photo-diode indicates that the pH of the medium reaches a predetermined level different from the original ambient pH of the medium. The light sensitive circuitry 15 can measure the change of color in the material 20. Thus, the pH sensitive material, modified by the analyte or analytes in the medium, becomes the indicator for the circuitry 15.

Suitable inert materials for use herein include any inert material known to one skilled in the art. Suitable inert materials include, but are not limited to, cellulose, cellulose acetates and sol-gels, e.g., silica-based gel such as, e.g., methyltriethoxysilane (MTEOS)). A preferred inert material for use herein is MTEOS. The pH indicators are those that will advantageously reflect a change in the pH level of the material being monitored. Suitable pH indicators for use herein are indicators that respond to pH changes in the range of from about 12 to about 14. A preferred pH indicator for use herein is trinitrobenzene sulfonic acid (TNBS).

Generally, mixing the inert material with the pH indicator in the presence of a catalyst such as, e.g., NaOH or KOH, and water, form pH sensitive material 20. For example, the catalyst can be first mixed with the inert material (MTEOS) to form a first solution and then further mixed with the pH indicator. Alternatively, the catalyst can be mixed with the pH indicator and then the inert material can be added thereto to form the solution. The components of the mixture are ordinarily mixed for a time period ranging from about 1 hour to about several (3) days. The amount of the individual components (e.g., H₂O, MTEOS, KOH and TNBS) used to make the material 20 can vary over a wide range, e.g., a molar ratio of H₂O: MTEOS:KOH:TNBS ranging from about 3:1:0.000001:0.000001 to about 6:1:0.1:0.1 can be advantageously employed.

Once the pH sensitive material is formed, the material is then deposited on at least a portion of the transparent surface 14 of housing 12. Techniques for depositing the pH sensitive material 20 on the transparent surface 14 are within the purview of one skilled in the art, e.g., by manual application using an applicator, or automated/semi-automated processes such as dip-coating and/or spin coating. The pH sensitive material is generally deposited on the transparent surface at a thickness ranging from about 0.1 mm to about 2 mm and preferably from about 0.5 mm to about 1 mm. The pH sensitive material is then allowed to dry under, for example, ambient temperature in an atmosphere saturated with ethanol, methanol or isopropyl alcohol for a time period of at least 1 day to about 7 days.

The pH sensor systems of the present disclosure are particularly useful for monitoring the pH level of a medium which is susceptible to degradation when the pH level of the medium reaches a predetermined level. The mediums to be monitored herein are those which possess an ambient pH level in the range of from about 12 to about 14. Examples of these mediums include, but are not limited to, concrete, soil, storage tanks for chemical reagents, e.g., NaOH, KOH, etc., biological mediums and the like. Generally, the pH sensor system is first embedded in the medium to be monitored.

With reference to FIG. 2, the LED and the light sensitive circuitry are powered by a power source 30 such as, for example, a rechargeable nickel-cadmium or lithium-ion battery or a super capacitor. It is contemplated that the power source can be internal to the sensor housing when the sensor is embedded in concrete or soil, and external to the sensor housing, when the sensor is immersed in a fluid inside a chemical container or a tank. Power source 30 is linked to an external power source such as a battery for recharging the power source 30. The link can be either through an inductive coupling or direct wire contacts. It is contemplated that power source 30 can be placed outside housing 12. Power source 30 is connected to a relay 32 and a resistor R Relay 32 and resister R provide overcurrent protection to LED 16, as known in the art. LED 16 constantly emits light upon being powered by power source 30. The light is preferably directed toward transparent surface 14 where it is gradually reflected back as incident light by pH sensitive material 20 as material 20 becomes increasingly saturated with hydrogen ions therefore indicating that the pH of the medium being monitored is decreasing.

While LED 16 is emitting light, a voltmeter/A-D converter or lock-in amplifier/A-D converter 34 connected in parallel to photo-detector 18 measures the voltage across photo-detector 18. The measured voltage is outputted via a data link 36 to a processor, e.g., a processor within a laptop computer.

The power source 30 powers the LED 16, photo-detector 18, voltmeter/A-D converter or lock-in amplifier/A-D converter 34 and data link 36.

As the pH sensitive material 20 becomes steadily saturated, the dye absorbs less and less light. Therefore, the amount of incident light reflected back and detected by the photo-detector 18 is greater than when the pH sensitive material 20 is not saturated. As a result, the voltage across the photo-detector 18 increases as is known in the art. Accordingly, voltmeter/A-D converter 34 outputs this voltage via data link 36 which enables an operator to determine that pH sensitive material 20 is becoming saturated due to a decrease in the ambient pH level.

The operator can determine the ambient pH level by relating the measured voltage across the photo-detector 18 with the corresponding pH level using a chart or table that relates voltage to pH level. As stated above the actual level of voltage depends upon the details of the electronics (such as amplifier and A/D converter) employed to measure the voltage. It also depends upon the wavelength of the light (of the LED source). For example, if the wavelength of the light is about 355±20 nm, then if the voltage of the photo-diode reaches about 500% of its original value, the pH of the medium reaches a predetermined level different from the original ambient pH of the medium thereby indicating that the medium has turned corrosive, as discussed herein. If the wavelength of the light is about 425±20 nm, then an about 120% increase in the output voltage of the photo-diode indicates a similar change in pH.

The following non-limiting examples are illustrative of the method for monitoring the pH level of a medium employing a pH sensor system in accordance with the present disclosure.

### EXAMPLES

This example illustrates the preparation of the pH sensitive material for use in the pH sensor system of this disclosure.

I. Preparation of Sol-Gel Films Incorporating TNBS

The sol-gel on which each of the films is based was prepared using a 6:1 molar ratio of water to methytriethoxysilane (MTEOS) to ensure more complete hydrolysis and formation of siloxane bonds and allowing for more pH indicator to be incorporated into the film. The pH indicator used for these experiments was trinitrobenzene sulfonic acid, a colorimetric dye, that responds to pH changes in the pH 12-14 range with an absorbance maximum at 355 nm. In order to incorporate the indicator into the sol-gel matrix, a 9.34 mM solution of TNBS in distilled water was prepared and substituted for the water component in the preparation of a sol-gel thin film.

First, several solutions of the sol-gel-TNBS composite were prepared as follows. A 6:1 ratio of TNBS solution and MTEOS were combined and stirred for 48-52 hours to allow for homogenization of the precursor solution. A catalyst in the form of 0.5-2.0 μL of a 10 M solution of potassium hydroxide in water was added to some samples and the solution was stirred for 30-60 seconds before casting the film while another sample remained uncatalyzed and films were prepared without further modification of the precursor solution. The variation in pH was kept small so as to reduce the generally detrimental effects of increasing pH on the stability of the film. Small pH changes, however, do have an important effect on the absorbance of the film.

The compositions of the chemicals used in preparing the sol-gel-TNBS composites are summarized below in Table I. Several tests were conducted using the prepared films to get statistically valid data.

TABLE I

| | Volume | Volume | Volume 10 M | Molar ratio | Molar ratio |
|---|---|---|---|---|---|
| Sample | MTEOS (mL) | H₂O (mL) | KOH (μL) | H₂O/MTEOS | H₂O/MTEOS/KOH |
| 1 | 2.983 | 1.62 | 0.0 | 6:1 | 6:1:0 |
| 2 | 2.983 | 1.62 | 0.5 | 6:1 | 6:1:0.000333 |
| 3 | 2.983 | 1.62 | 2.0 | 6:1 | 6:1:0.00133 |

Sample 1 contains no TNBS and is outside the scope of this disclosure. Samples 2 and 3 contain TNBS, which is within the scope of this disclosure, and were prepared using a 9.34 mM solution of TNBS in distilled water.

Thin films of each of the samples were prepared by spreading approximately 0.8 mL of the pH sensitive solution over an approximately one inch square area of prepared glass microscope slide. The surfaces were prepared by rinsing with warm tap water and Mr. Clean brand cleaning solution (containing sodium hydroxide). The surfaces were then rinsed twice with distilled water and hung to dry in a covered beaker. Surfaces were cleaned no more than 12 hours prior to application of the pH sensitive solution. Once the films were applied they were allowed to cure flat under an inverted beaker at ambient temperature for at least one week before any tests were conducted.

The properties of the sol-gel-TNBS pH sensitive films were first characterized using a spectrometer. Absorbance spectra in the 200-600 nm range were taken of each film. For this purpose, a baseline for absorbance was established using two films of identical composition without TNBS (Sample 1). Next, two films of both Samples 2 and 3 (films containing TNBS) were used to obtain spectra of the TNBS relative to that of a blank sol-gel film.

The spectrometer data were used to confirm the presence of TNBS in the films; in all cases films made with TNBS showed the absorbance spectrum characteristic of that dye, with a large peak around 355 nm and a smaller peak around 425 nm. The absorbance spectra indicated that the absorbance of the film increased with increasing pH.

II. Experimental Set-Up

A light is shined from an LED, and the photo-diode senses the reflected light from the same side. The LED used in these experiments emitted light with a band of spectrum centered around the wavelength of 455 nm. The LED was modulated (turned “on” and “off”) at 100 Hz. A Teflon® tape was placed on the back of the composite to provide a good reflecting surface for the incident light.

FIG. 3 shows the LED/Glas-Slide/Photo-diode arrangement. A paper screen blocks the scattered light from the LED from reaching the photodiode directly without passing first through the sample.

The first set of experiments consisted of calibration of the pH sensitive material, with and without TNBS, using the experimental setup shown in FIG. 4. The results of the experiments are set forth below in Table II.

TABLE II

| | Intensity of | | |
|---|---|---|---|
| | Light After | Standard | Number of |
| Sample | Absorbance <x> (V) | Deviation (s) | Samples (V) |
| 1 | 7.7147 | 0.06375 | 17 |
| 2 | 7.5150 | 0.05923 | 20 |
| 3 | 7.3090 | 0.05251 | 20 |

As shown from the data in Table 2, the degree of absorbance increases when the pH sensitive material is formed with TNBS. It also shows that the degree of absorbance (in presence of TNBS) increased with the increase in the KOH molar ratio. However, increasing that ratio beyond 1.33·10⁻³ caused the pH sensitive film to flake.

III. pH Sensitive Material Coated with Concrete

In each of these experiments, 3 g of cement was combined with 1 mL of water, which produced a paste. The wet concrete had a pH of approximately 12.8 as measured with Litmus paper. Typically wet concrete has a pH of around 13. A layer of cement approximately 3-4 mm thick was then applied over an approximately one inch square area over the pH sensitive films prepared from Samples 1-3, and the films were placed into a sample holder and allowed to dry for 4-8 hours as generally depicted in FIG. 5.

Table III below shows the absorbance data for each of these samples.

TABLE III

| | Intensity of | | |
|---|---|---|---|
| | Light After | Standard | Number of |
| Sample | Absorbance <x> (V) | Deviation (s) | Samples (V) |
| 1 | 3.4515 | 0.02368 | 20 |
| 2 | 3.0110 | 0.03695 | 20 |
| 3 | 2.9350 | 0.04640 | 20 |

IV. Conclusions

As seen from these data, the pH sensitive films containing TNBS (i.e., samples 2 and 3) can be incorporated into a concrete system in such a way that the pH in concrete could be detected. The films used appear to be durable, maintaining the same physical and optical properties after being immersed in a pH environment of about 13 for several days, thus providing a viable platform for a long-term embedded sensor in concrete.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A pH sensor system comprising:
a housing having at least one transparent surface;
a light sensing circuitry enclosed within the housing; and,
a chromatic pH sensitive material overlaying at least a portion of the transparent surface having the characteristic of becoming saturated when an ambient pH level reaches a predetermined level, wherein the light sensing circuitry detects a different intensity of incident light when the chromatic pH sensitive material is saturated than when the chromatic pH sensitive material is not saturated.

2. The pH sensor system of claim 1 wherein the housing is a material selected from the group consisting of ceramic material, plastic material, nylon, concrete, epoxy and combinations thereof.

3. The pH sensor system of claim 1 wherein the transparent surface comprises glass or sapphire.

4. The pH sensor system of claim 1 wherein the pH sensitive material comprises an inert material and a pH indicator.

5. The pH sensor system of claim 4 wherein the inert material is cellulose, cellulose acetate or a silica-based gel.

6. The pH sensor system of claim 4 wherein the pH indicator is trinitrobenzene sulfonic acid.

7. The pH sensor system of claim 4 wherein the pH sensitive material further comprises a catalyst selected from the group consisting of sodium hydroxide, potassium hydroxide, water and mixtures thereof.

8. The pH sensor system of claim 1 wherein the pH sensitive material comprises an inert material selected from the group consisting of cellulose, cellulose acetate or a silica-based gel, trinitrobenzene sulfonic acid and a catalyst selected from the group consisting of sodium hydroxide, potassium hydroxide, water and mixtures thereof.

9. The pH sensor system of claim 1 wherein the light sensing circuitry comprises a light emitting diode capable of emitting light and a photo-detector capable of detecting incident light reflected by the transparent surface.

10. The pH sensor system of claim 1 wherein the light sensing circuitry is powered by a power source.

11. The pH sensor system of claim 10 wherein the power source is inside or outside the housing.

12. The pH sensor system of claim 11 wherein the power source is a battery or capacitor.

13. The pH sensor system of claim 9 wherein the light sensing circuitry further comprises a voltage meter and A/D converter.

14. The pH sensor system of claim 9 wherein the light sensing circuitry further comprises a lock-in amplifier and A/D converter.

15. The pH sensor system of claim 1 wherein the ambient pH level is from about 12 to about 14 and the predetermined pH level is less than or equal to about 12.

16. The pH sensor system of claim 8 wherein the ambient pH level is from about 12 to about 14 and the predetermined pH level is less than or equal to about 12.

17. A method for monitoring the pH level of a medium comprising the steps of:
providing a pH sensor system comprising a housing having at least one transparent surface; a light sensing circuitry enclosed within the housing; and, a chromatic pH sensitive material overlaying at least a portion of the transparent surface having the characteristic of becoming saturated when an ambient pH level reaches a predetermined level such that the light sensing circuitry detects a different intensity of incident light when the chromatic pH sensitive material is saturated than when the chromatic pH sensitive material is not saturated; and,
embedding the pH sensor system within the medium to be monitored.

18. The method of claim 17 wherein the medium possesses a pH level from about 12 to about 14.

19. The method of claim 17 wherein the medium is selected from the group consisting of concrete, soil, storage tanks containing chemical reagents or biological mediums.

20. The method of claim 19 wherein the chemical reagents in the storage tank are an alkali medium.

21. The method of claim 20 wherein the alkali medium is selected from the group consisting of potassium hydroxide, sodium hydroxide and mixtures thereof.

22. The method of claim 17 wherein the housing of the pH sensor system is a material selected from the group consisting of ceramic material, plastic material, nylon, concrete, epoxy and combinations thereof.

23. The method of claim 17 wherein the transparent surface of the housing comprises glass or sapphire.

24. The method of claim 17 wherein the light sensing circuitry is powered by a power source.

25. The method of claim 24 wherein the power source is inside or outside the housing.

26. The method of claim 24 wherein the power source is a battery or capacitor.

27. The method of claim 17 wherein the pH sensitive material comprises an inert material and a pH indicator.

28. The method of claim 27 wherein the inert material is cellulose, cellulose acetate or a silica-based gel.

29. The method of claim 27 wherein the pH indicator is trinitrobenzene sulfonic acid.

30. The method of claim 27 wherein the pH sensitive material further comprises a catalyst selected from the group consisting of sodium hydroxide, potassium hydroxide, water and mixtures thereof.

31. The method of claim 17 wherein the pH sensitive material comprises an inert material selected from the group consisting of cellulose, cellulose acetate or a silica-based gel, trinitrobenzene sulfonic acid and a catalyst selected from the group consisting of sodium hydroxide, potassium hydroxide, water and mixtures thereof.

32. The method of claim 17 wherein the light sensing circuitry comprises a light emitting diode capable of emitting light and a photo-detector capable of detecting incident light reflected by the transparent surface.

33. The method of claim 32 wherein the light sensing circuitry further comprises a voltage meter and A/D converter.

34. The method of claim 32 wherein the light sensing circuitry further comprises a lock-in amplifier and A/D converter.

35. The method of claim 17 wherein the ambient pH level is from about 12 to about 14 and the predetermined pH level is less than or equal to about 12.

36. The method of claim 24 wherein the ambient pH level is from about 12 to about 14 and the predetermined pH level is less than or equal to about 12.

37. A pH sensor system comprising:
a housing having at least one transparent surface;
a light sensing circuitry enclosed within the housing; and, a chromatic pH sensitive material comprising an inert material and a pH indicator capable of indicating a pH of less than or equal to about 12 and overlaying at least a portion of the transparent surface having the characteristic of becoming saturated when an ambient pH level reaches a predetermined level of less than or equal to about 12, wherein the light sensing circuitry detects a different intensity of incident light when the chromatic pH sensitive material is saturated than when the chromatic pH sensitive material is not saturated.

38. The pH sensor system of claim 37 wherein the housing is a material selected from the group consisting of ceramic material, plastic material, nylon, concrete, epoxy and combinations thereof and the transparent surface comprises glass or sapphire.

39. The pH sensor system of claim 37 wherein the pH sensitive material comprises an inert material selected from the group consisting of cellulose, cellulose acetate or a silica-based gel, trinitrobenzene sulfonic acid and a catalyst selected from the group consisting of sodium hydroxide, potassium hydroxide, water and mixtures thereof.

40. The pH sensor system of claim 37 wherein the light sensing circuitry comprises a light emitting diode capable of emitting light and a photo-detector capable of detecting incident light reflected by the transparent surface.

41. The pH sensor system of claim 37 wherein the light sensing circuitry is powered by a power source.

42. The pH sensor system of claim 41 wherein the power source is inside or outside the housing.

43. The pH sensor system of claim 41 wherein the power source is a battery or capacitor.

44. The pH sensor system of claim 40 wherein the light sensing circuitry further comprises a voltage meter and A/D converter.

45. The pH sensor system of claim 40 wherein the light sensing circuitry further comprises a lock-in amplifier and A/D converter.

46. The pH sensor system of claim 37 wherein the ambient pH level is from about 12 to about 14.

47. A method for monitoring the pH level of a medium comprising the steps of:
providing the pH sensor system of claim 37; and,
embedding the pH sensor system within a medium selected from the group consisting of concrete, soil and storage tanks containing a chemical reagent.

48. The method of claim 47 wherein the housing is a material selected from the group consisting of ceramic material, plastic material, nylon, concrete, epoxy and combinations thereof and the transparent surface comprises glass or sapphire.

49. The method of claim 47 wherein the pH sensitive material comprises an inert material selected from the group consisting of cellulose, cellulose acetate or a silica-based gel, trinitrobenzene sulfonic acid and a catalyst selected from the group consisting of sodium hydroxide, potassium hydroxide, water and mixtures thereof.

50. The method of claim 47 wherein the light sensing circuitry comprises a light emitting diode capable of emitting light and a photo-detector capable of detecting incident light reflected by the transparent surface.

51. The method of claim 47 wherein the light sensitive circuitry is powered by a power source.

52. The method of claim 51 wherein the power source is inside or outside the housing.

53. The method of claim 51 wherein the power source is a battery or capacitor.

54. The method of claim 50 wherein the light sensing circuitry further comprises a voltage meter and A/D converter.
